(19) United States
(12) Patent Application Publication
(10) Pub. No.: US 2019/0074534 A1
(43) Pub. Date: Mar. 7, 2019

(54) FUEL CELL STACK AND FUEL CELL

(71) Applicant: NGK INSULATORS, LTD., Nagoya-shi (JP)

(72) Inventors: Yohei MIURA, Yokohama-shi (JP); Noriyuki OGASAWARA, Nagoya-shi (JP); Makoto OHMORI, Nagoya-shi (JP)

(21) Appl. No.: 16/179,075

(22) Filed: Nov. 2, 2018

Related U.S. Application Data
(63) Continuation of application No. PCT/JP2017/030705, filed on Aug. 28, 2017.

(30) Foreign Application Priority Data
Aug. 29, 2016 (JP) 2016-167114
Jul. 6, 2017 (JP) 2017-133080

(51) Int. Cl. H01M 8/2465; H01M 8/12; H01M 8/023

(52) U.S. Cl. CPC H01M 8/2465; H01M 8/023; H01M 8/12

(57) ABSTRACT

A fuel cell stack includes a fuel manifold and a fuel cell. The fuel cell extends from the fuel manifold. The fuel cell includes a support substrate and a plurality of electricity generating elements. The support substrate includes a gas flow pathway extending along a lengthwise direction. The plurality of electricity generating elements are disposed on the support substrate, while being disposed away from each other at intervals along the lengthwise direction. A base end-side electricity generating element disposed as gas supply-side endmost one of the plurality of electricity generating elements has an area greater than an average area of the plurality of electricity generating elements except for the base end-side electricity generating element.

### CROSS-REFERENCE TO RELATED APPLICATIONS

This application is a continuation application of PCT/JP2017/030705, filed Aug. 28, 2017, which claims priority to Japanese Application Nos. 2016-167114 filed Aug. 29, 2016 and 2017-133080 filed Jul. 6, 2017, the entire contents all of which are incorporated herein by reference.

### TECHNICAL FIELD

The present invention relates to a fuel cell stack and a fuel cell.

### BACKGROUND ART

A fuel cell stack includes a fuel manifold and a plurality of fuel cells extending from the fuel manifold (PTL 1). Each fuel cell includes a support substrate and a plurality of electricity generating elements. The support substrate includes a gas flow pathway extending in the lengthwise direction thereof. The electricity generating elements are disposed on the support substrate, while being aligned at intervals in the lengthwise direction.

### CITATION LIST

### Patent Literature

PTL 1: Japan Patent No. 5551803

### SUMMARY OF THE INVENTION

### Technical Problems

It has been demanded to enhance electricity generating efficiency in the aforementioned type of fuel cell stacks. In view of this, it is an object of the present invention to enhance electricity generating efficiency.

### Solution to Problems

As a result of keen study, the inventors of the present invention found that an electricity generating element disposed on a gas supply side acts as a factor to deteriorate electricity generating efficiency of each fuel cell. Specifically, the electricity generating elements are supplied with fuel gas and air, and accordingly, generate electricity. When the fuel gas or air to be supplied is not sufficiently heated in advance, a base end-side electricity generating element, which is the gas supply-side endmost one of the electricity generating elements, is inevitably cooled by the fuel gas or air. As a result, electric resistance becomes inevitably larger in the base end-side electricity generating element than in the other electricity generating elements, whereby deterioration in electricity generating efficiency is concerned in each fuel cell.

In view of the above, a fuel cell stack according to a first aspect of the present invention includes a fuel manifold and a fuel cell. The fuel cell extends from the fuel manifold. The fuel cell includes a support substrate and a plurality of electricity generating elements. The support substrate includes a gas flow pathway extending along a lengthwise direction. The plurality of electricity generating elements are disposed on the support substrate. Additionally, the plurality of electricity generating elements are disposed away from each other at intervals along the lengthwise direction. A base end-side electricity generating element disposed as gas supply-side endmost one of the plurality of electricity generating elements has an area greater than an average area of the plurality of electricity generating elements except for the base end-side electricity generating element.

According to this configuration, the area of the base end-side electricity generating element disposed as the gas supply-side endmost electricity generating element is greater than the average area of the plurality of electricity generating elements except for the base end-side electricity generating element. Hence, the current density of the base end-side electricity generating element is made small, whereby the electric resistance thereof can be made small. As a result, even when the electric resistance of the base end-side electricity generating element is increased by lowering of temperature, difference in electric resistance can be made small between the base end-side electricity generating element and each of the plurality of electricity generating elements except for the base end-side electricity generating element. Therefore, the fuel cell can be enhanced in electricity generating efficiency.

Preferably, the area of the base end-side electricity generating element is greatest among areas of the plurality of electricity generating elements.

Preferably, the area of the base end-side electricity generating element is greater than an area of a middle electricity generating element disposed as middle one of the plurality of electricity generating elements in the lengthwise direction. Normally, the temperature of the middle electricity generating element disposed as the lengthwise directional middle electricity generating element becomes the highest. Hence, difference in electric resistance becomes the largest between the middle electricity generating element and the base end-side electricity generating element. In view of this, difference in electric resistance can be reduced between the base end-side electricity generating element and the middle electricity generating element by making the area of the base end-side electricity generating element larger than that of the middle electricity generating element. As a result, the fuel cell can be enhanced in electricity generating efficiency.

The area of the base end-side electricity generating element may be equal to an area of a distal end-side electricity generating element disposed as gas discharge-side endmost one of the plurality of electricity generating elements. In this case, the area of the base end-side electricity generating element is not required to be completely equal to that of the distal end-side electricity generating element, and difference can be produced therebetween due to manufacturing errors.

Preferably, a ratio (Sa/S0) of the area (Sa) of the base end-side electricity generating element to the average area (S0) of the plurality of electricity generating elements except for the base end-side electricity generating element is greater than or equal to 1.1.

A fuel cell according to a second aspect of the present invention includes a support substrate and a plurality of electricity generating elements. The support substrate includes a gas flow pathway extending along a lengthwise direction. The plurality of electricity generating elements are disposed on the support substrate, while being disposed away from each other at intervals along the lengthwise direction. A base end-side electricity generating element disposed as gas supply-side endmost one of the plurality of electricity generating elements has an area greater than an average area of the plurality of electricity generating elements except for the base end-side electricity generating element.

According to this configuration, the area of the base end-side electricity generating element disposed as the gas supply-side endmost electricity generating element is greater than the average area of the plurality of electricity generating elements except for the base end-side electricity generating element. Hence, the current density of the base end-side electricity generating element is made small, whereby the electric resistance thereof can be made small. As a result, even when the electric resistance of the base end-side electricity generating element is increased by lowering of temperature, difference in electric resistance can be made small between the base end-side electricity generating element and each of the plurality of electricity generating elements except for the base end-side electricity generating element. Therefore, the fuel cell can be enhanced in electricity generating efficiency.

### Advantageous Effects of Invention

According to the fuel cell stack of the present invention, electricity generating efficiency can be enhanced.

### BRIEF DESCRIPTION OF THE DRAWINGS

FIG. 1 is a perspective view of a fuel cell stack.

FIG. 2 is a cross-sectional view of the fuel cell stack.

FIG. 3 is a perspective view of a fuel manifold.

FIG. 4 is a perspective view of a fuel cell.

FIG. 5 is a cross-sectional view of the fuel cell.

FIG. 6 is a front view of the fuel cell stack.

FIG. 7 is a cross-sectional view of the fuel cell.

FIG. 8 is a diagram showing joint parts between the fuel cells and the fuel manifold.

FIG. 9 is a diagram showing a method of supplying gas to the fuel cell stack.

FIG. 10 is a cross-sectional view of the fuel cell and shows flow directions of electric current.

FIG. 11 is a diagram showing a method of manufacturing the fuel cell stack.

FIG. 12 is a diagram showing the method of manufacturing the fuel cell stack.

FIG. 13 is a schematic diagram of a fuel cell according to a practical example.

### DESCRIPTION OF EMBODIMENTS

An exemplary embodiment of a fuel cell stack according to the present invention will be hereinafter explained with reference to drawings.

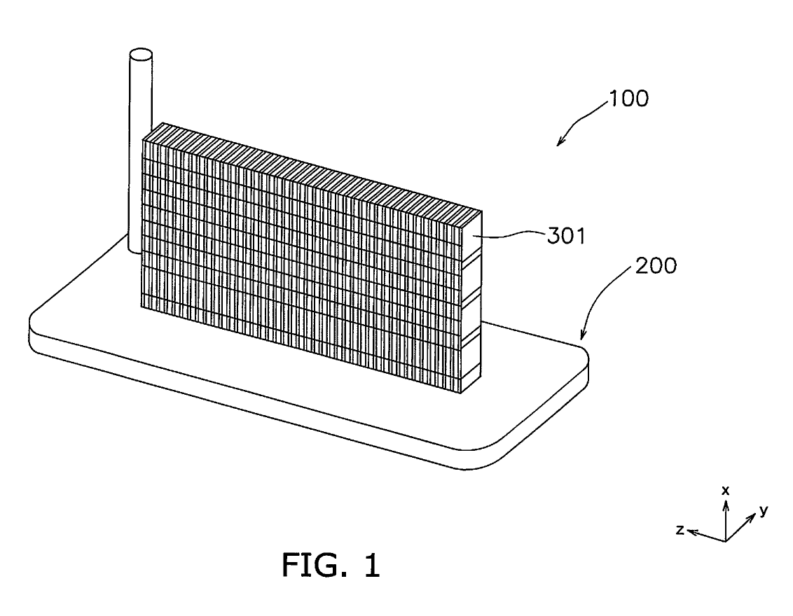

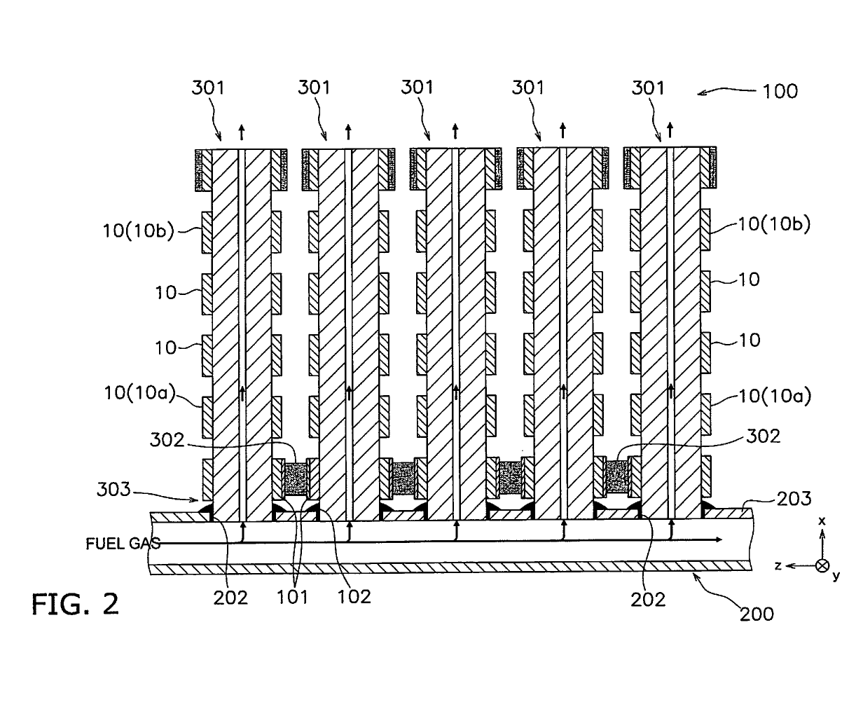

As shown in FIGS. 1 and 2, a fuel cell stack 100 includes a fuel manifold 200 and a plurality of fuel cells 301.

[Fuel Manifold]

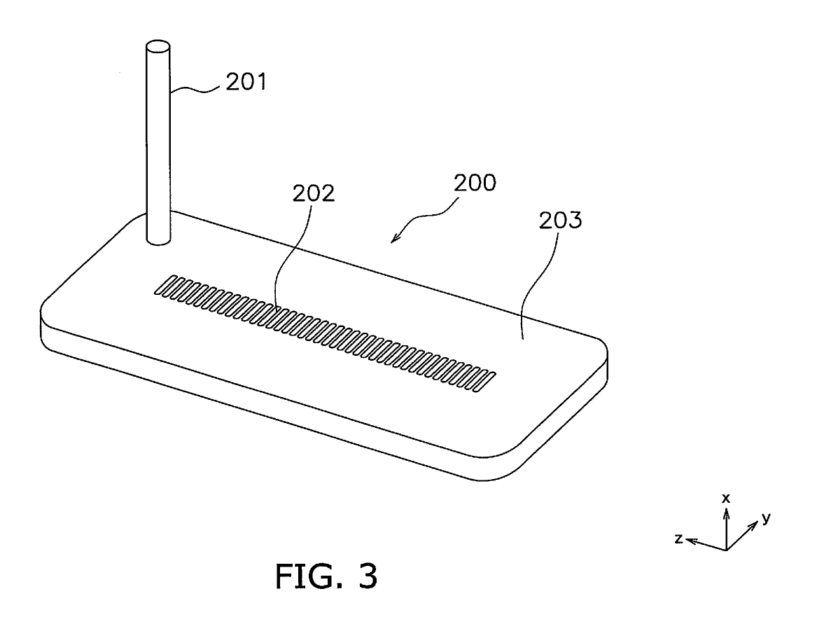

As shown in FIG. 3, the fuel manifold 200 is configured to distribute fuel gas to the respective fuel cells 301. The fuel manifold 200 is hollow and includes an internal space. The fuel gas is supplied to the internal space of the fuel manifold 200 through an introduction tube 201. The fuel manifold 200 includes a plurality of through holes 202 aligned away from each other at intervals. The through holes 202 are provided in a top plate 203 of the fuel manifold 200. The through holes 202 make the internal space of the fuel manifold 200 and the outside communicate with each other therethrough.

Fuel Cells

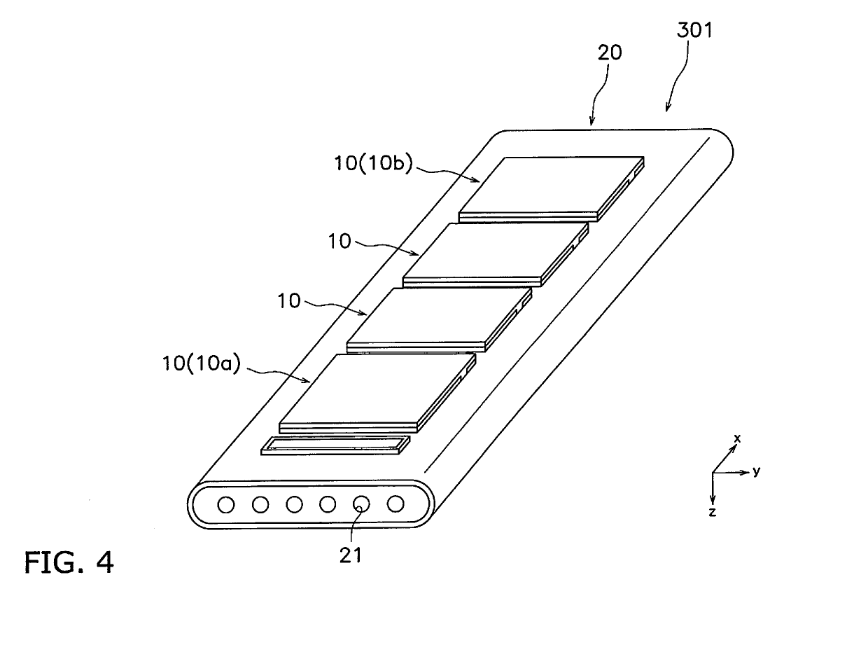

As shown in FIG. 2, each fuel cell 301 extends from the fuel manifold 200. In detail, each fuel cell 301 extends upward (in an X-axis direction) from the top plate 203 of the fuel manifold 200. In other words, the lengthwise direction (the x-axis direction) of each fuel cell 301 extends upward. As shown in FIG. 4, each fuel cell 301 includes a plurality of electricity generating elements 10 and a support substrate 20.

Support Substrate

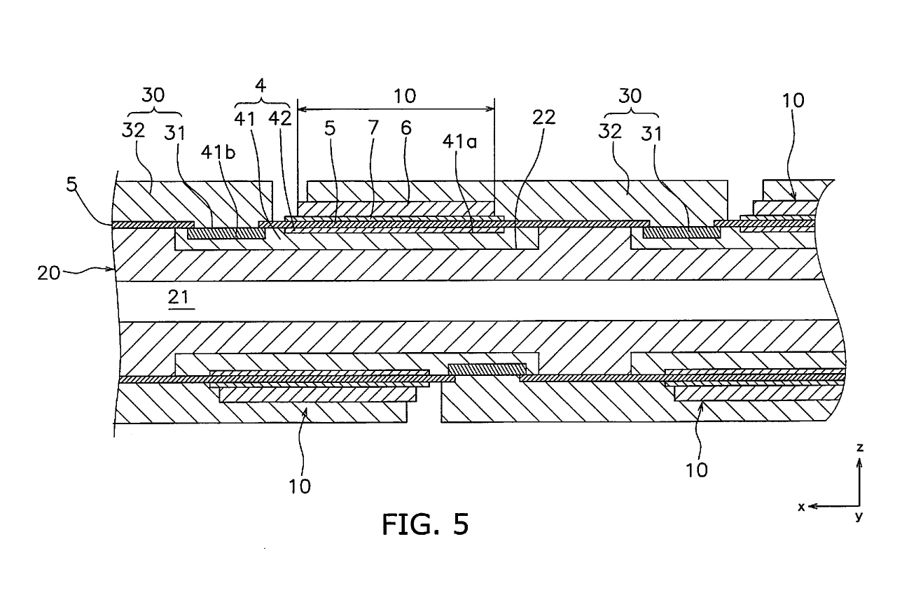

The support substrate 20 includes, in the interior thereof, a plurality of gas flow pathways 21 extending in the lengthwise direction (the x-axis direction) of the support substrate 20. The gas flow pathways 21 extend substantially in parallel to each other. As shown in FIG. 5, the support substrate 20 includes a plurality of first recesses 22. The first recesses 22 are provided on the both faces of the support substrate 20. The first recesses 22 are disposed away from each other at intervals in the lengthwise direction of the support substrate 20. It should be noted that the first recesses 22 are not provided on the both ends of the support substrate 20 in the width direction (a y-axis direction) thereof.

The support substrate 20 is made of porous material without electronic conductivity. The support substrate 20 can be made of, for instance, CSZ (calcia stabilized zirconia). Alternatively, the support substrate 20 may be made of any of the following combinations: NiO (nickel oxide) and YSZ (8YSZ: yttria stabilized zirconia); NiO (nickel oxide) and Y₂O₃ (yttria); and MgO (magnesium oxide) and MgAl₂O₄ (magnesia alumina spinel). The support substrate 20 has a pore rate of, for instance, roughly 20 to 60%.

Electricity Generating Elements

The respective electricity generating elements 10 are supported by the both faces of the support substrate 20. It should be noted that the respective electricity generating elements 10 may be supported by only one of the both faces of the support substrate 20. The respective electricity generating elements 10 are disposed away from each other at intervals in the lengthwise direction of the support substrate 20. In other words, each fuel cell 301 according to the present exemplary embodiment is a so-called horizontal stripe type fuel cell. Each pair of the electricity generating elements 10, disposed adjacent to each other in the lengthwise direction, is electrically connected to each other through an electric connecting portion 30.

Each electricity generating element 10 includes a fuel pole 4, an electrolyte 5 and an air pole 6. Additionally, each electricity generating element 10 further includes a reaction preventing film 7. The fuel pole 4 is a fired body made of porous material with electronic conductivity. The fuel pole 4 includes a fuel pole electron collecting portion 41 and a fuel pole activating portion 42.

The fuel pole electron collecting portion 41 is disposed within each first recess 22. In detail, the fuel pole electron collecting portion 41 is filled in each first recess 22, and has a similar contour to each first recess 22. The fuel pole electron collecting portion 41 includes a first recess 41a and a third recess 41b. The fuel pole activating portion 42 is disposed in the second recess 41a. In detail, the fuel pole activating portion 42 is filled in the second recess 41a.

The fuel pole electron collecting portion 41 can be made of, for instance, NiO (nickel oxide) and YSZ (8YSZ: yttria stabilized zirconia). Alternatively, the fuel pole electron collecting portion 91 may be made of NiO (nickel oxide) and Y₂O₃ (yttria), or yet alternatively, may be made of NiO (nickel oxide) and CSZ (calcia stabilized zirconia). The thickness of the fuel pole electron collecting portion 41 and the depth of each first recess 22 are both roughly 50 to 500 μm.

The fuel pole activating portion 42 can be made of, for instance, NiO (nickel oxide) and YSZ (8YSZ: yttria stabilized zirconia). Alternatively, the fuel pole activating portion 42 may be made of NiO (nickel oxide) and GDC (gadolinium doped ceria). The thickness of the fuel pole activating portion 42 is 5 to 30 μm.

The electrolyte 5 is disposed to cover the fuel pole 4 from above. In detail, the electrolyte 5 extends from a given one to another of inter-connectors 31 in the lengthwise direction. In other words, the electrolytes 5 and the inter-connectors 31 are alternately disposed in the lengthwise direction of each fuel cell 301.

The electrolyte 5 is a fired body made of dense material with ion conductivity but without electronic conductivity. The electrolyte 5 can be made of, for instance, YSZ (8YSZ: yttria stabilized zirconia). Alternatively, the electrolyte 5 may be made of LSGM (lanthanum gallate). The thickness of the electrolyte 5 is, for instance, roughly 3 to 50 μm.

The reaction preventing film 7 is a fired body made of dense material, and has approximately the same shape as the fuel pole activating portion 42 as seen in a plan view (a z-axis directional view). The reaction preventing film 7 is disposed in a corresponding position to the fuel pole activating portion 42, while the electrolyte 5 is interposed therebetween. The reaction preventing film 7 is provided for inhibiting occurrence of a phenomenon that a chemical reaction is caused between YSZ contained in the electrolyte 5 and Sr contained in the air pole 6, whereby a reaction layer with a large electric resistance is formed on the boundary between the electrolyte 5 and the air pole 6. The reaction preventing film 7 can be made of, for instance, GDC=(Ce,Gd)O₂ (gadolinium doped ceria). The thickness of the reaction preventing film 7 is, for instance, roughly 3 to 50 μm.

The air pole 6 is disposed on the reaction preventing film 7. The air pole 6 is a fired body made of porous material with electronic conductivity. The air pole 6 can be made of, for instance, LSCF=(La,Sr)(Co, Fe)O₃ (lanthanum strontium cobalt ferrite). Alternatively, the air pole 6 may be made of LSF=(La,Sr)FeO₃ (lanthanum strontium ferrite), LNF=La(Ni,Fe)O₃ (lanthanum nickel ferrite), LSC=(La,Sr)CoO₃ (lanthanum strontium cobaltite) or so forth. The air pole 6 may be composed of two layers including a first layer (inner layer) made of LSCF and a second layer (outer layer) made of LSC. The thickness of the air pole 6 is, for instance, 10 to 100 μm.

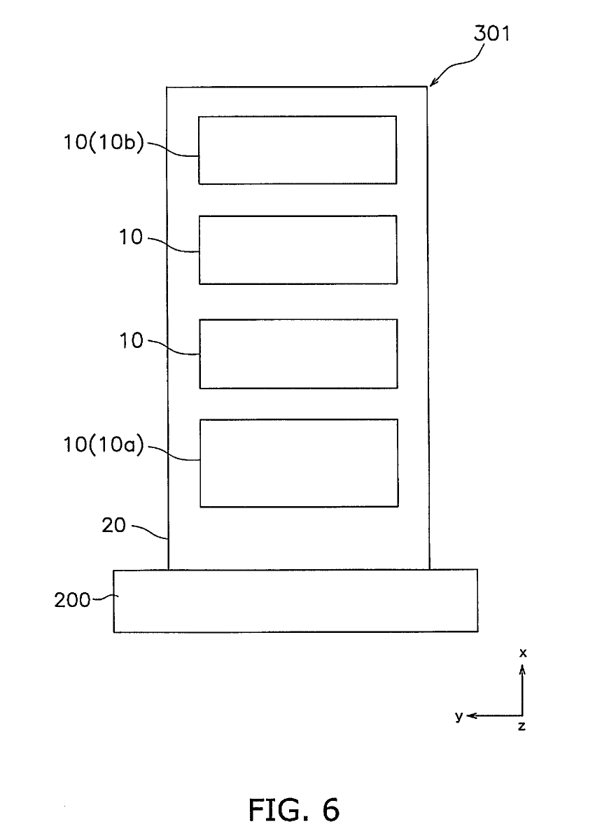

As shown in FIG. 6, the respective electricity generating elements 10 are disposed at intervals along the lengthwise direction (the x-axis direction) of the support substrate 20. Among the electricity generating elements 10, the gas supply-side endmost one (lowermost one in FIG. 6) will be defined as a base end-side electricity generating element 10a. It should be noted that the term “gas supply side” refers to a side to which gas is supplied, i.e., the fuel manifold 200 side. The gas supply-side endmost electricity generating element 10 is synonymous to the electricity generating element 10 closest to the fuel manifold 200. Additionally, among the electricity generating elements 10, the gas discharge-side endmost one (uppermost one in FIG. 6) will be defined as a distal end-side electricity generating element 10b. It should be noted that the term “gas discharge side” is a side from which gas is discharged, i.e., the opposite side of the fuel manifold 200. The position of the distal end-side electricity generating element 10b is farthest from the fuel manifold 200 among the positions of the electricity generating elements 10.

The area of the base end-side electricity generating element 10a is larger than the average area of the other electricity generating elements 10. It should be noted that the term “area of the electricity generating element 10” refers to the area of a part in which the fuel pole activating portion 42, the electrolyte 5 and the air pole 6 overlap as seen in a view along the thickness direction of the electricity generating element 10 (the z-axis directional view). The area of the base end-side electricity generating element 10a is preferably made larger than that of the respective other electricity generating elements 10 by setting the width directional (y-axis directional) dimension thereof to be equal to that of the respective other electricity generating elements 10 but by setting the lengthwise directional (x-axis directional) dimension thereof to be different from that of the respective other electricity generating elements 10.

Comparison is made among the areas of the electricity generating elements 10 regarding each of the faces of the support substrate 20 on which the electricity generating elements 10 are provided. For example, when the electricity generating elements 10 are provided on the both faces of the support substrate 20, the area of the base end-side electricity generating element 10a provided on one face of the support substrate 20 is designed to be larger than the average area of the other electricity generating elements 10 provided on the one face of the support substrate 20. Likewise, the area of the base end-side electricity generating element 10a provided on the other face of the support substrate 20 is designed to be larger than the average area of the other electricity generating elements 10 provided on the other face of the support substrate 20.

The base end-side electricity generating element 10a preferably has the largest area among the electricity generating elements 10. For example, the base end-side electricity generating element 10a has a larger area than each of all the other electricity generating elements 10. It should be noted that at least one of the other electricity generating elements 10 may have an equal area to the base end-side electricity generating element 10a. For example, the distal-end side electricity generating element 10b may have an equal area to the base end-side electricity generating element 10a.

Additionally, the base end-side electricity generating element 10a has a larger area than a middle electricity generating element 10 disposed in the lengthwise directional middle among the electricity generating elements 10. It should be noted that when an even number of the electricity generating elements 10 are disposed on the support substrate 20, two electricity generating elements 10 are configured to be disposed in the lengthwise directional middle. Additionally, the base end-side electricity generating element 10a has a larger area than each of these two electricity generating elements 10.

It is preferable to set a ratio Sa/S0, which is a ratio of an area Sa of the base end-side electricity generating element 10a to an average area S0 of the other electricity generating elements 10, to be greater than or equal to 1.1. Additionally, it is preferable to set the ratio Sa/S0 to be less than or equal to 2.5.

Electric Connecting Portions

As shown in FIG. 5, each electric connecting portion 30 is configured to electrically connect two electricity generating elements 10 disposed in adjacent to each other in the lengthwise direction of the support substrate 20. Each electric connecting portion 30 includes the inter-connector 31 and an air pole electron collecting film 32. The inter-connector 31 is disposed in each third recess 41b. In detail, the inter-connector 31 is buried (and filled) in each third recess 91b. The inter-connector 31 is a fired body made of dense material with electronic conductivity. The inter-connector 31 can be made of, for instance, LaCrO₃ (lanthanum chromite). Alternatively, the inter-connector 31 may be made of (Sr, La) TiO₃ (strontium titanate). The thickness of the inter-connector 31 is, for instance, 10 to 100 μm.

The air pole electron collecting film 32 is disposed to extend between the inter-connector 31 and the air pole 6 of adjacent two electricity generating elements 10. For example, the air pole electron collecting film 32 is disposed to electrically connect the air pole 6 of the electricity generating element 10 disposed on the left side in FIG. 5 and the inter-connector 31 of the electricity generating element 10 disposed on the right side in FIG. 5. The air pole electron collecting film 32 is a fired body made of porous material with electronic conductivity.

The air pole electron collecting film 32 can be made of, for instance, LSCF=(La,Sr)(Co,Fe)O₃ (lanthanum strontium cobalt ferrite). Alternatively, the air pole electron collecting film 32 may be made of LSC=(La,Sr)CoO₃ (lanthanum strontium cobaltite). Yet alternatively, the air pole electron collecting film 32 may be made of Ag (silver) or Ag—Pd (silver-palladium alloy). The thickness of the air pole electron collecting film 32 is, for instance, roughly 50 to 500 μm.

Electron Collecting Members

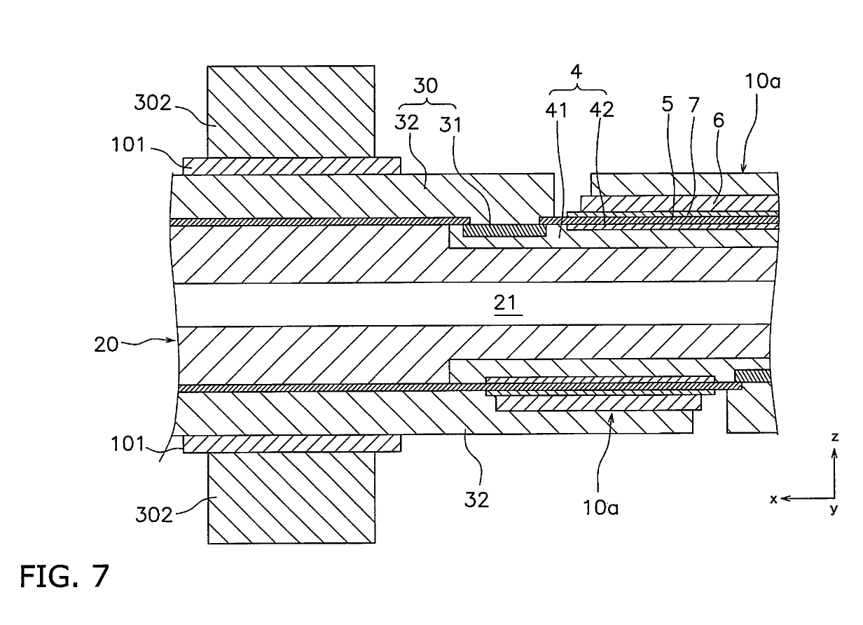

A given one of the fuel cells 301 configured as described above is electrically connected to another adjacent thereto through an electron collecting member 302. As shown in FIG. 2, each electron collecting member 302 is disposed between each pair of fuel cells 301. Then, each electron collecting member 302 has electric conductivity so as to electrically connect two fuel cells 301 disposed in adjacent to each other in the thickness direction (z-axis direction). In detail, each electron collecting member 302 connects adjacent two fuel cells 301 on a gas supply side 303 of the fuel cells 301. Each electron collecting member 302 is disposed closer to the gas supply side than the base end-side electricity generating elements 10a. In detail, as shown in FIG. 7, each electron collecting member 302 is disposed on the air pole electron collecting film 32 extending from each base end-side electricity generating element 10a.

Each electron collecting member 302 is made in the shape of a block. For example, each electron collecting member 302 is made in the shape of a cuboid or a cylinder. Each electron collecting member 302 is made of, for instance, a fired body of oxide ceramics. For example, perovskite oxide, spinel oxide or so forth can be exemplified as oxide ceramics described above. For example, (La,Sr)MnO₃, (La,Sr)(Co,Fe)O₃ or so forth can be exemplified as perovskite oxide. For example, (Mn,Co)₃O₄, (Mn,Fe)₃O₄ or so forth can be exemplified as spinel oxide. Each electron collecting member 302 does not have, for instance, flexibility.

Each electron collecting member 302 is joined to each fuel cell 301 through each of first joint members 101. In other words, each first joint member 101 joins each electron collecting member 302 and each fuel cell 301. Each first joint member 101 is, for instance, at least one selected from the group consisting of (Mn,Co)₃O₄, (La,Sr)MnO₃, (La,Sr)(Co,Fe)O₃ and so forth.

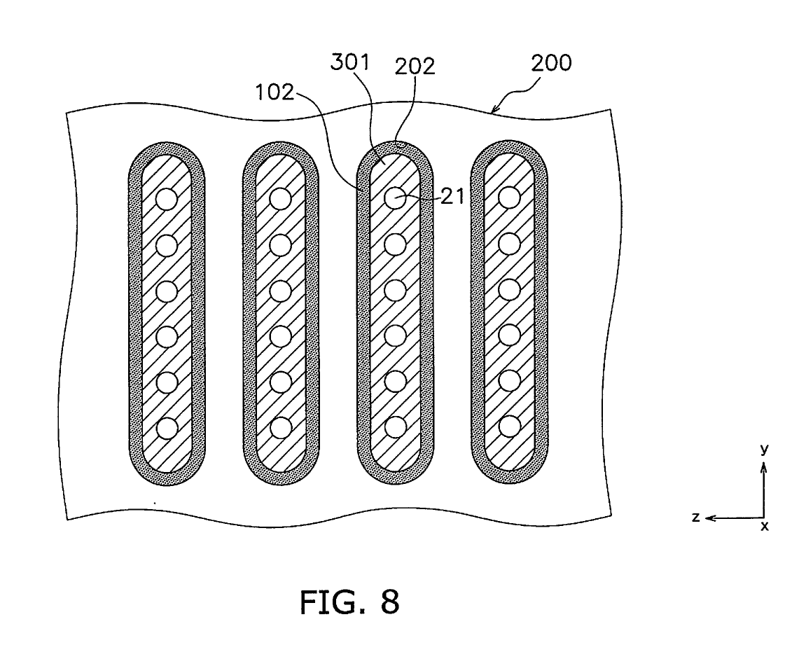

As shown in FIG. 2, the respective fuel cells 301 are supported by the fuel manifold 200. In detail, the fuel cells 301 are fixed to the top plate 203 of the fuel manifold 200 by second joint members 102, respectively. In more detail, as shown in FIG. 8, the fuel cells 301 are inserted into the through holes 202 of the fuel manifold 200, respectively. The fuel cells 301 are fixed to the fuel manifold 200 by the second joint members 102, respectively, while being inserted into the through holes 202, respectively.

Each second joint member 102 is filled in each through hole 202 in which each fuel cell 301 is inserted. In other words, each second joint member 102 is filled in a gap between the outer peripheral surface of each fuel cell 301 and the wall surface by which each through hole 202 is delimited. Each second joint member 102 are made of, for instance, crystallized glass. For example, crystallized glass to be employable is of a SiO₂—B₂O₃, SiO₂—CaO or SiO₂—MgO system. It should be noted that in the present specification, the term “crystallized glass” refers to glass in which a ratio of “a volume occupied by crystal phase” to the entire volume (i.e., degree of crystallization) is greater than or equal to 60% while a ratio of “a volume occupied by amorphous phase and impurity” to the entire volume is less than 40%. It should be noted that amorphous glass, brazing filler metal, ceramics or so forth may be employed as the material of which each second joint member 102 is made. Specifically, each second joint member 102 is made of at least one selected from the group consisting of SiO₂—MgO—B₂O₅—Al₂O₃ system and SiO₂—MgO—Al₂O₃—ZnO system.

The length of each fuel cell 301 protruding from the fuel manifold 200 in the lengthwise direction (x-axis direction) can be set to roughly 100 to 300 mm. Additionally, the fuel cells 301 are aligned at intervals in the thickness direction (z-axis direction) thereof. The interval between adjacent two of the fuel cells 301 can be set to roughly 1 to 5 mm.

Method of Generating Electricity

The fuel cell stack 100 configured as described above generates electricity as follows. Fuel gas (hydrogen gas, etc.) is fed into the gas flow pathways 21 of each fuel cell 301 through the fuel manifold 200, and simultaneously, the both faces of the support substrate 20 are exposed to oxygen-contained gas (air, etc.).

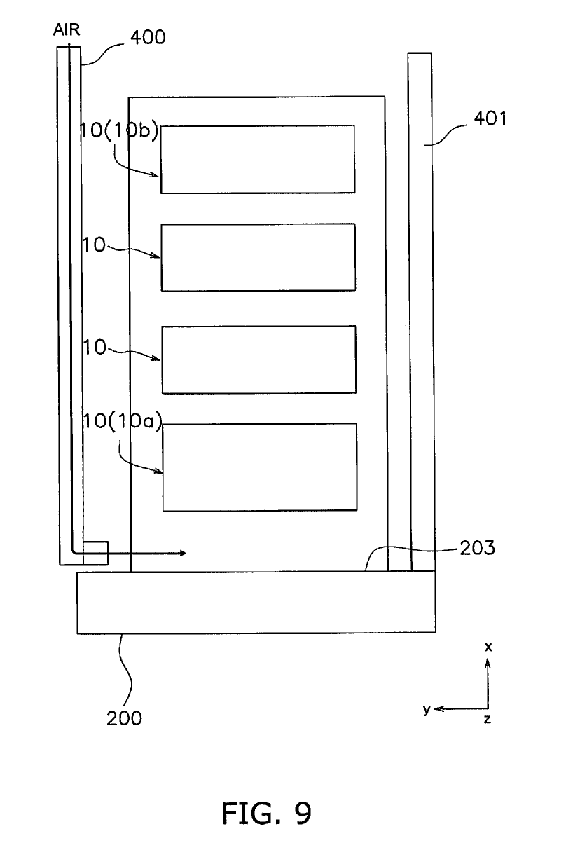

For example, as shown in FIG. 9, the oxygen-contained gas is supplied to the gas supply side of the base end-side electricity generating element 10a so as to flow along the width direction (y-axis direction). In detail, the fuel cell stack 100 further includes a gas supply member 400. The gas supply member 400 is configured to supply gas such as air between the fuel cells 301. It should be noted that a guide plate 401 may be installed on the opposite side of the gas supply member 400 such that the gas supplied from the gas supply member 400 efficiently flows upward. The guide plate 401 is made in the shape of a flat plate, and extends not only in the lengthwise direction of each fuel cell 301 but also in the thickness direction of each fuel cell 301.

As described above, an electromotive force is generated by difference in partial pressure of oxygen caused between the both lateral sides of the electrolyte 5 in each electricity generating element 10 to which the fuel gas and the oxygen-contained gas are supplied. When the fuel cell stack 100 is connected to an external load, an electrochemical reaction shown in the following equation (1) is caused on the air pole 6 whereas an electrochemical reaction shown in the following equation (2) is caused on the fuel pole 4. This results in flow of electric current.

(½)·O₂+2e⁻→O² (1)

H₂+O²⁻→H₂O+2e⁻ (2)

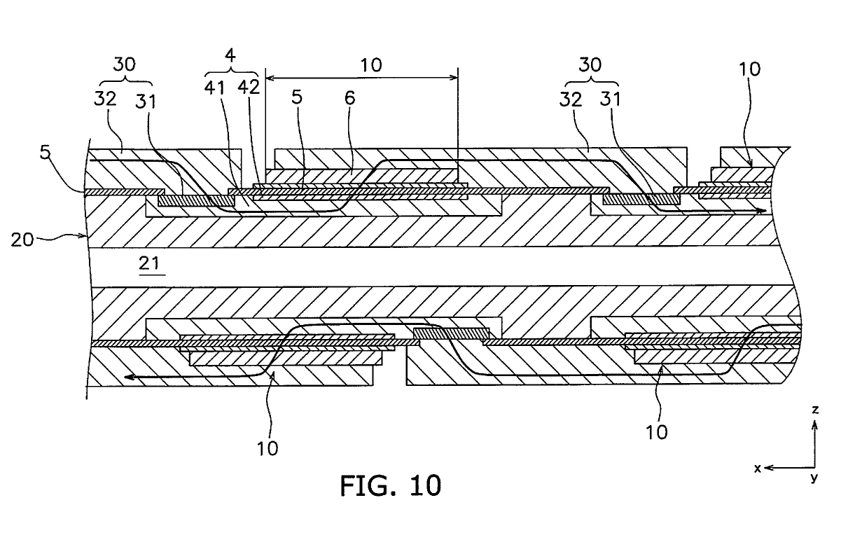

In an electricity generated state, electric current flows as depicted with arrows in FIG. 10. Electric current flows in the thickness direction at each inter-connector 31 and each electricity generating element 10.

Manufacturing Method

Next, a method of manufacturing the fuel cell stack configured as described above will be explained.

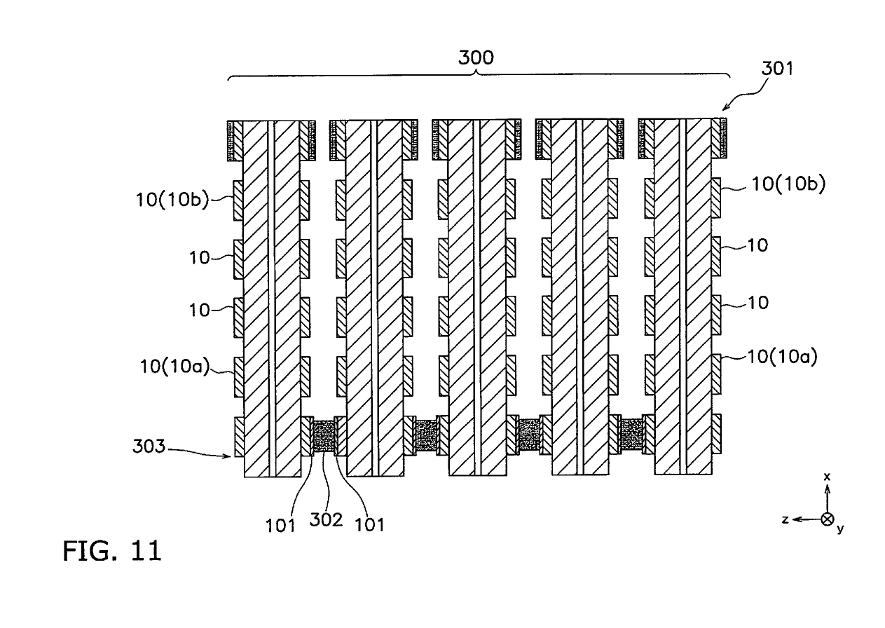

First, the fuel manifold 200 and the plurality of fuel cells 301 are prepared. Then, as shown in FIG. 11, a cell assembly 300 is fabricated by connecting the respective fuel cells 301 to each other through the electron collecting members 302 and the first joint members 101. It should be noted that in this manufacturing phase, the first joint members 101 have not been fired yet, and the respective fuel cells 301 are temporarily fixed to each other.

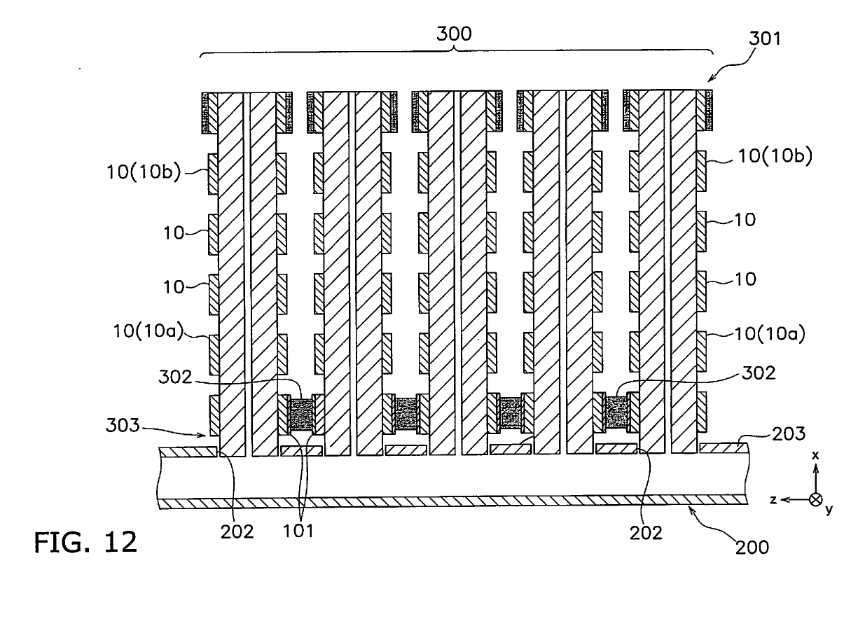

Next, as shown in FIG. 12, the ends of the fuel cells 301 of the cell assembly 300 are inserted into the through holes 202 of the fuel manifold 200, respectively. It should be noted that a jig may be used for keeping the fuel cells 301 at predetermined intervals along the thickness direction.

Next, the second joint members 102 are filled in the through holes 202, respectively, in which the fuel cells 301 are inserted. It should be noted that the second joint members 102 are preferably filled in the through holes 202, respectively, enough to upwardly spill out beyond the surface of the support plate.

Next, thermal treatment is applied to the first joint members 101 and the second joint members 102. Through the thermal treatment, the first joint members 101 and the second joint members 102 are solidified, and thus, the fuel cell stack 100 is completed. In detail, the first joint members 101 are fired through the thermal treatment applied thereto. As a result, the fuel cells 301 and the electron collecting members 302 are fixed to each other. Additionally, the amorphous material, of which the second joint members 102 are made, reaches a crystallization temperature through the thermal treatment applied to the second joint members 102. Then, crystal phase is generated in the interior of the material at the crystallization temperature, and thus, crystallization of the material proceeds. As a result, the amorphous material is solidified into ceramics, and is obtained as crystallized glass. Accordingly, each second joint member 102 made of crystallized glass serves a function thereof, and each fuel cell 301 is fixed at the proximal end thereof to the fuel manifold 200. Thereafter, the predetermined jig is removed from the fuel cell stack 100.

Modifications

One exemplary embodiment of the present invention has been explained above. However, the present invention is not limited to this, and a variety of changes can be made without departing from the gist of the present invention.

Modification 1

In the aforementioned exemplary embodiment, the support substrate 20 is made in the shape of a flat plate, but alternatively, may be made in the shape of a cylinder. In other words, each fuel cell 301 may be made in the shape of a cylinder.

Modification 2

No restraint is imposed on the area settings for the electricity generating elements 10 as long as the area of the base end-side electricity generating element 10a is larger than the average area of the other electricity generating elements 10 in at least one of the plural fuel cells 301. For example, in some of the plural fuel cells 301, the area of the base end-side electricity generating element 10a may be smaller than or equal to the area of each of the other electricity generating elements 10.

### PRACTICAL EXAMPLES

A practical example and a comparative example will be hereinafter described to further specifically explain the present invention. It should be noted that the present invention is not limited to the following practical example.

The fuel cells 301, to which No. 1 to No. 10 were assigned, were fabricated as follows.

The fuel cells 301, each of which was configured as described above, were fabricated. Each fuel cell 301 includes eight electricity generating elements 10 disposed at intervals in the lengthwise direction. The electricity generating elements 10 were connected in series through the electric connecting portions 30. It should be noted that the electricity generating elements 10 were formed only one of the faces of the support substrate 20.

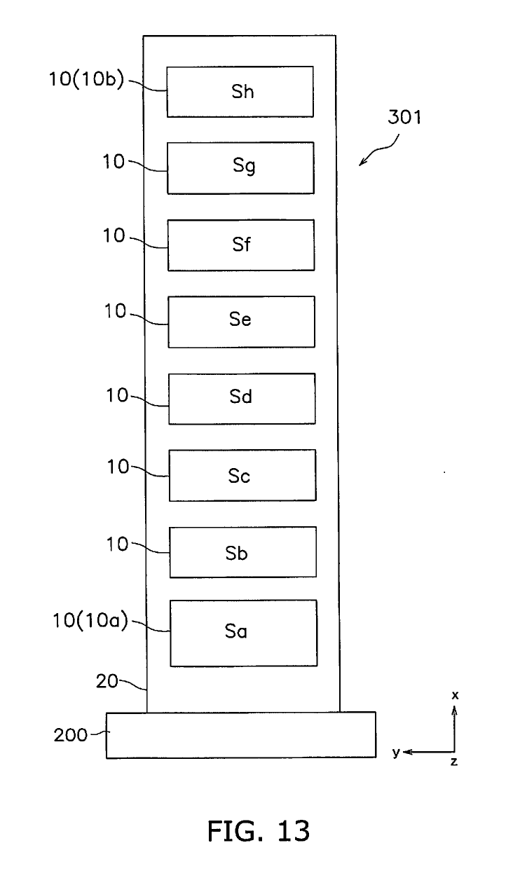

In each fuel cell 301, areas Sa to Sh of the electricity generating elements 10 were set as shown in Table 1. It should be noted that the areas Sa to Sh of the electricity generating elements 10 are expressed by area ratio, where the area Sa of the base end-side electricity generating element 10a is set to 1. The areas Sa to Sh of the electricity generating elements 10 are sequentially aligned in a condition that the area Sa is located as the gas supply-side endmost one (see FIG. 13). Additionally, the width directional dimensions of the electricity generating elements 10 were set to be equal, and hence, the lengthwise directional dimensions thereof were adjusted to adjust the areas thereof. Moreover, the configurations of the electricity generating elements 10, except for the areas thereof, are the same as each other in each fuel cell 301. In Table 1, S0 indicates the average area of the other electricity generating elements 10 except for the base end-side electricity generating element 10a in each fuel cell 301.

Assessment Method

The fuel cells 301, fabricated as described above, were inserted into the single fuel manifold 200, and fuel gas was supplied to the gas flow pathways 21 of the fuel cells 301 through the fuel manifold 200. Additionally, air was supplied along the width direction from below the base end-side electricity generating element 10a. Then, electromotive forces in each fuel cell 301 were measured, and each sample was assessed. This assessment result is shown in Table 1. It should be noted that assessment was made under the condition of a temperature of 750 degrees Celsius, an electric current density of 0.2 A/cm², a fuel use rate of 80% and an air use rate of 40%.

TABLE 1

| | | | | | | | | | | | AVERAGE | |
|---|---|---|---|---|---|---|---|---|---|---|---|---|
| | | | | | | | | | | | OUTPUT | |
| | | | | | | | | | | | VOLTAGE (V) | |
| | | | | | | | | | | | OF | |
| | | | | | | | | | | | ELECTRICITY | |
| | | | | | | | | | | | GENERATING | ASSESSMENT |
| No. | Sa | Sb | Sc | Sd | Se | Sf | Sg | Sh | S0 | Sa/S0 | ELEMENTS | RESULT |
| 1 | 1.00 | 1.00 | 1.00 | 1.00 | 1.00 | 1.00 | 1.00 | 1.00 | 1.00 | 1.00 | 0.720 | X |
| 2 | 1.00 | 0.95 | 0.95 | 0.95 | 0.95 | 0.95 | 0.95 | 0.95 | 0.95 | 1.05 | 0.760 | ◯ |
| 3 | 1.00 | 0.95 | 0.95 | 0.95 | 0.95 | 0.90 | 0.90 | 0.90 | 0.93 | 1.08 | 0.770 | ◯ |
| 4 | 1.00 | 0.95 | 0.90 | 0.90 | 0.90 | 0.90 | 0.90 | 0.90 | 0.91 | 1.10 | 0.790 | [symbol] |
| 5 | 1.00 | 0.80 | 0.80 | 0.80 | 0.80 | 0.80 | 0.80 | 0.80 | 0.80 | 1.25 | 0.810 | [symbol] |
| 6 | 1.00 | 0.90 | 0.80 | 0.70 | 0.70 | 0.70 | 0.70 | 0.70 | 0.74 | 1.35 | 0.805 | [symbol] |
| 7 | 1.00 | 0.95 | 0.90 | 0.85 | 0.80 | 0.75 | 0.60 | 0.60 | 0.78 | 1.28 | 0.812 | [symbol] |
| 8 | 1.00 | 0.75 | 0.75 | 0.50 | 0.50 | 0.50 | 0.50 | 0.50 | 0.57 | 1.75 | 0.806 | [symbol] |
| 9 | 1.00 | 0.40 | 0.40 | 0.40 | 0.40 | 0.40 | 0.40 | 0.40 | 0.40 | 2.50 | 0.805 | [symbol] |
| 10 | 1.00 | 0.80 | 0.80 | 0.80 | 0.80 | 0.80 | 0.80 | 1.00 | 0.83 | 1.21 | 0.811 | [symbol] |

Based on Table 1, it was found that the electromotive force is increased in magnitude by setting the area Sa of the base end-side electricity generating element 10a to be larger than the average area S0 of the other electricity generating elements 10. It was also found that the electromotive force is further increased in magnitude by setting the ratio (Sa/S0) of the area Sa of the base end-side electricity generating element 10a to the average area S0 of the other electricity generating elements 10 to be greater than or equal to 1.10.

### REFERENCE SIGNS LIST

100 Fuel cell stack
200 Fuel manifold
301 Fuel cell
10 Electricity generating element
10a Base end-side electricity generating element
10b Distal end-side electricity generating element
20 Support substrate
21 Gas flow pathway

What is claimed is:

1. A fuel cell stack comprising:
a fuel manifold; and
a fuel cell extending from the fuel manifold, the fuel cell including a support substrate and a plurality of electricity generating elements, the support substrate including a gas flow pathway extending along a lengthwise direction, the plurality of electricity generating elements being disposed on the support substrate, the plurality of electricity generating elements being disposed away from each other at intervals along the lengthwise direction, wherein
a base end-side electricity generating element disposed as gas supply-side endmost one of the plurality of electricity generating elements has an area greater than an average area of the plurality of electricity generating elements except for the base end-side electricity generating element.

2. The fuel cell stack according to claim 1, wherein the area of the base end-side electricity generating element is greatest among areas of the plurality of electricity generating elements.

3. The fuel cell stack according to claim 1, wherein the area of the base end-side electricity generating element is greater than an area of a middle electricity generating element disposed as middle one of the plurality of electricity generating elements in the lengthwise direction.

4. The fuel cell stack according to claim 1, wherein the area of the base end-side electricity generating element is equal to an area of a distal end-side electricity generating element disposed as gas discharge-side endmost one of the plurality of electricity generating elements.

5. The fuel cell stack according to claim 1, wherein a ratio (Sa/S0) of the area (Sa) of the base end-side electricity generating element to the average area (S0) of the plurality of electricity generating elements except for the base end-side electricity generating element is greater than or equal to 1.1.

6. A fuel cell comprising:
a support substrate including a gas flow pathway extending along a lengthwise direction; and
a plurality of electricity generating elements disposed on the support substrate, the plurality of electricity generating elements being disposed away from each other at intervals along the lengthwise direction, wherein
a base end-side electricity generating element disposed as gas supply-side endmost one of the plurality of electricity generating elements has an area greater than an average area of the plurality of electricity generating elements except for the base end-side electricity generating element.
